(19) United States
(12) Patent Application Publication
(10) Pub. No.: US 2026/0064145 A1
(43) Pub. Date: Mar. 5, 2026

(54) Circuit Device

(71) Applicant: SEIKO EPSON CORPORATION, Tokyo (JP)

(72) Inventor: Tetsuo TAKAGI, Okaya (JP)

(21) Appl. No.: 19/312,719

(22) Filed: Aug. 28, 2025

(30) Foreign Application Priority Data
Aug. 29, 2024 (JP) 2024-147334

(51) Int. Cl. G05F 1/577; G05F 1/46

(52) U.S. Cl. CPC G05F 1/577; G05F 1/468

(57) ABSTRACT

A circuit device includes a bias voltage generation circuit that generates a first bias voltage and a second bias voltage with reference to a power supply voltage, outputs the first bias voltage to a first bias node, and outputs the second bias voltage to a second bias node, a first follower circuit that outputs a first output voltage following the first bias voltage, a second follower circuit that outputs a second output voltage following the second bias voltage, and a first potential fixing circuit that fixes a potential of the first bias node to a potential of a power supply node in a rising time of the power supply voltage.

The present application is based on, and claims priority from JP Application Serial Number 2024-147334, filed Aug. 29, 2024, the disclosure of which is hereby incorporated by reference herein in its entirety.

### BACKGROUND

### 1. Technical Field

The present disclosure relates to a circuit device or the like.

### 2. Related Art

JP-A-2009-301087 discloses a voltage adjustment system including voltage adjusting means and a plurality of stages coupled in parallel to the output of the voltage adjustment means. The voltage adjusting means generates a voltage using an amplifier circuit. The generated voltage is input to the gate of a source follower of each stage, and the source follower of each stage outputs an output voltage. In this way, the plurality of stages output a plurality of output voltages. The plurality of output voltages are generated based on the ground voltage.

JP-A-2009-301087 is an example of the related art.

In a circuit that generates an output voltage with a given potential difference with respect to a power supply voltage, that is, outputs an output voltage with reference to the power supply voltage, it is necessary to output an appropriate output voltage with respect to a change in the power supply voltage at the time of power activation. In JP-A-2009-301087, an output voltage is output based on the ground voltage, and a case where an output voltage is output based on a power supply voltage is not described.

### SUMMARY

An aspect of the present disclosure relates to a circuit device that generates a first output voltage and a second output voltage lower than the first output voltage from a power supply voltage supplied to a power supply node, the circuit device including a bias voltage generation circuit that generates a first bias voltage and a second bias voltage with reference to the power supply voltage, outputs the first bias voltage to a first bias node, and outputs the second bias voltage to a second bias node, a first follower circuit that outputs the first output voltage following the first bias voltage to a first output node, a second follower circuit that outputs the second output voltage following the second bias voltage to a second output node, and a first potential fixing circuit that fixes a potential of the first bias node to a potential of the power supply node in a rising time of the power supply voltage.

Another aspect of the present disclosure relates to a circuit device that generates a first output voltage and a second output voltage lower than the first output voltage from a power supply voltage supplied to a power supply node, the circuit device including a bias voltage generation circuit that generates a first bias voltage and a second bias voltage with reference to the power supply voltage, outputs the first bias voltage to a first bias node, and outputs the second bias voltage as the second output voltage to a second output node as a second bias node, a first follower circuit that outputs the first output voltage following the first bias voltage to a first output node, and a first potential fixing circuit that fixes a potential of the first bias node to a potential of the power supply node in a rising time of the power supply voltage.

### BRIEF DESCRIPTION OF THE DRAWINGS

FIG. 1 shows a first configuration example of a voltage generation circuit provided in a circuit device.

FIG. 2 shows a configuration example of a circuit device including the voltage generation circuit and a circuit in a subsequent stage.

FIG. 3 shows a first detailed configuration example of the voltage generation circuit.

FIG. 4 shows a second detailed configuration example of the voltage generation circuit.

FIG. 5 shows a signal waveform example illustrating an operation of the second detailed configuration example of the voltage generation circuit.

FIG. 6 shows a configuration example of a comparative example.

FIG. 7 shows a signal waveform example of the comparative example.

FIG. 8 shows a first other configuration example of a first potential fixing circuit.

FIG. 9 shows another configuration example of a second reference voltage setting circuit.

FIG. 10 shows another configuration example of a second potential fixing circuit.

FIG. 11 shows a second other configuration example of the first potential fixing circuit.

FIG. 12 shows a first other configuration example of a bias voltage generation circuit.

FIG. 13 shows a second other configuration example of the bias voltage generation circuit.

FIG. 14 shows a second configuration example of the voltage generation circuit provided in the circuit device.

FIG. 15 shows a more detailed configuration example of the second configuration example of the voltage generation circuit.

### DESCRIPTION OF EMBODIMENTS

A preferred embodiment of the present disclosure will be described in detail below. Note that the present embodiment to be described below does not unduly limit the description in What is claimed is and not all of the configurations described in the present embodiment are necessarily essential 1 component elements. Note that coupling in the present embodiment includes electrical coupling. The electrical coupling is coupling in which an electrical signal, a voltage, or a current can be transmitted, and includes coupling in which information can be transmitted by an electrical signal. The electrical coupling may be coupling via a passive element or an active element.

### 1. First Configuration Example

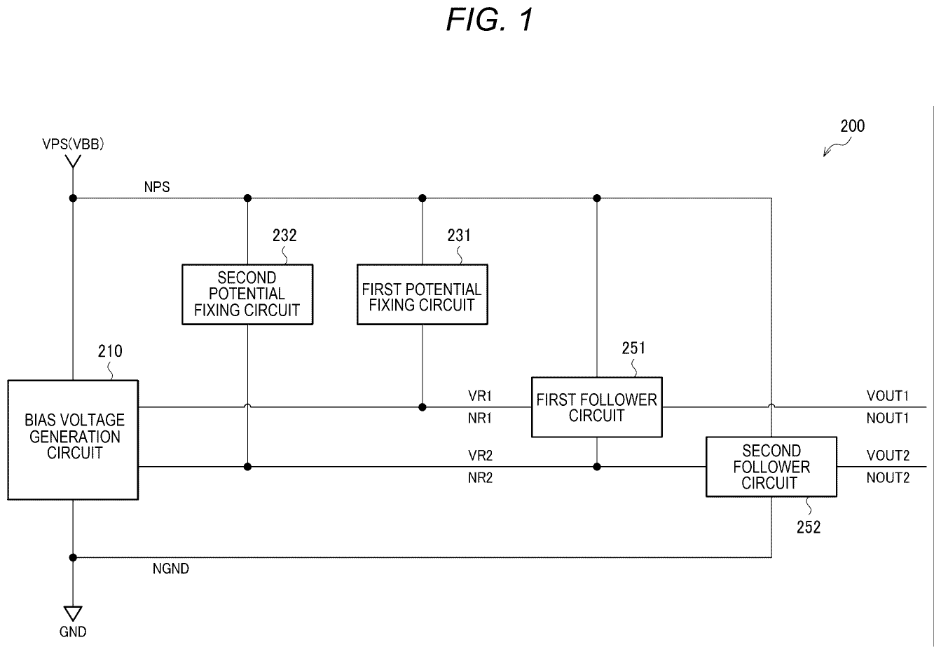

FIG. 1 shows a first configuration example of a voltage generation circuit 200 provided in a circuit device of the present embodiment. The voltage generation circuit 200 includes a bias voltage generation circuit 210, a first potential fixing circuit 231, a second potential fixing circuit 232, a first follower circuit 251, and a second follower circuit 252. The second potential fixing circuit 232 may be omitted. The circuit device may include only the voltage generation circuit 200 or may further include another circuit. The circuit device is, for example, an integrated circuit device in which a plurality of circuit elements are integrated on a semiconductor substrate.

A power supply node NPS is a node to which a power supply voltage VPS is supplied from a power supply. A ground node NGND is a node to which a ground voltage GND is supplied from the power supply. A power supply voltage VPS refers to a power supply voltage including a transient voltage fluctuation, and includes, for example, power supply voltages from the power supply before activation, at activation, and after activation. The power supply voltage after the power supply is activated and stabilized is referred to as a given power supply voltage VBB. The power supply may be provided outside the circuit device or may be built in the circuit device.

The bias voltage generation circuit 210 generates a first bias voltage VR1 and a second bias voltage VR2 with reference to the power supply voltage VPS, outputs the first bias voltage VR1 to a first bias node NR1, and outputs the second bias voltage VR2 to a second bias node NR2. Here, it is assumed that the power supply voltage VPS is the given power supply voltage VBB. The voltage with reference to the given power supply voltage VBB is a voltage generated to have a given voltage difference from the given power supply voltage VBB. The first bias voltage VR1 and the second bias voltage VR2 are set such that a second output voltage VOUT2 described later is lower than a first output voltage VOUT1. For example, the second bias voltage VR2 is lower than the first bias voltage VR1.

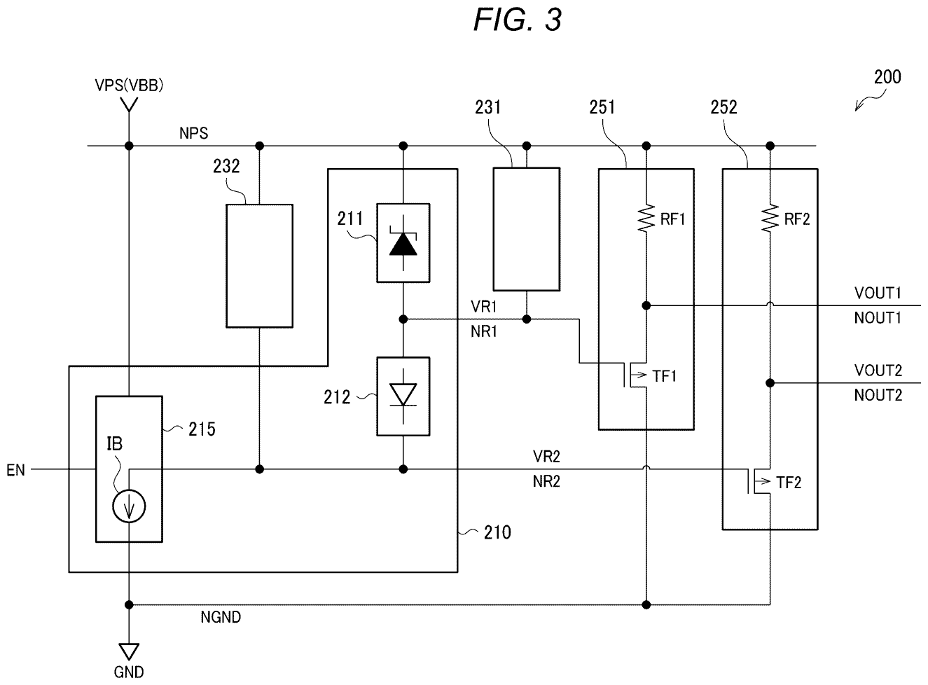

The first follower circuit 251 outputs the first output voltage VOUT1 following the first bias voltage VR1 to a first output node NOUT1. That is, the first follower circuit 251 outputs the first output voltage VOUT1 holding a given voltage difference from the first bias voltage VR1 or outputs the first output voltage VOUT1 having the same voltage value as the first bias voltage VR1. The first follower circuit 251 is, for example, a source follower circuit described with reference to FIG. 3 and the like, but may be a voltage follower circuit or the like. The voltage follower circuit is a circuit in which a negative input terminal and an output terminal of an operational amplifier are coupled, a positive input terminal of the operational amplifier is input of the voltage follower circuit, and an output terminal of the operational amplifier is output of the voltage follower circuit.

The second follower circuit 252 outputs the second output voltage VOUT2 following the second bias voltage VR2 to a second output node NOUT2. That is, the second follower circuit 252 outputs the second output voltage VOUT2 holding a given voltage difference from the second bias voltage VR2 or outputs the second output voltage VOUT2 having the same voltage value as the second bias voltage VR2. The second follower circuit 252 is, for example, a source follower circuit described with reference to FIG. 3 and the like, but may be a voltage follower circuit or the like.

The first potential fixing circuit 231 fixes the potential of the first bias node NR1 to the potential of the power supply node NPS in the rising time of the power supply voltage VPS. That is, when the power supply is activated and the power supply voltage VPS is raised to the given power supply voltage VBB from the vicinity of the ground voltage GND, the first potential fixing circuit 231 fixes the potential of the first bias node NR1 so that the first bias voltage VR1 and the power supply voltage VPS during rising become equal to each other. The rising time of the power supply voltage VPS includes at least a period until the power supply voltage VPS reaches the given power supply voltage VBB. For example, as will be described with reference to FIG. 3 and the like, after the power supply voltage VPS becomes the given power supply voltage VBB, the bias voltage generation circuit 210 is enabled to start generation of a bias voltage. Here, the rising time of the power supply voltage VPS may be a period until the bias voltage generation circuit 210 is enabled.

The second potential fixing circuit 232 fixes the potential of the second bias node NR2 to the potential of the power supply node NPS in the rising time of the power supply voltage VPS. That is, when the power supply is activated and the power supply voltage VPS is raised to the given power supply voltage VBB from a lower voltage around 0 V or the like, the second potential fixing circuit 232 fixes the potential of the second bias node NR2 so that the second bias voltage VR2 and the power supply voltage VPS during rising become equal to each other.

According to the present embodiment, in the rising time of the power supply voltage VPS, the first bias voltage VR1 is fixed to the power supply voltage VPS, thereby fixing the first output voltage VOUT1, which follows it, to the power supply voltage VPS. As a result, the influence on a circuit in the subsequent stage using the first output voltage VOUT1 can be reduced. As the influence, for example, malfunction, failure, or the like of the circuit in the subsequent stage is considered. Similarly, the second bias voltage VR2 is fixed to the power supply voltage VPS, thereby fixing the following second output voltage VOUT2 to the power supply voltage VPS. As a result, the influence on a circuit in the subsequent stage using the second output voltage VOUT2 can be reduced.

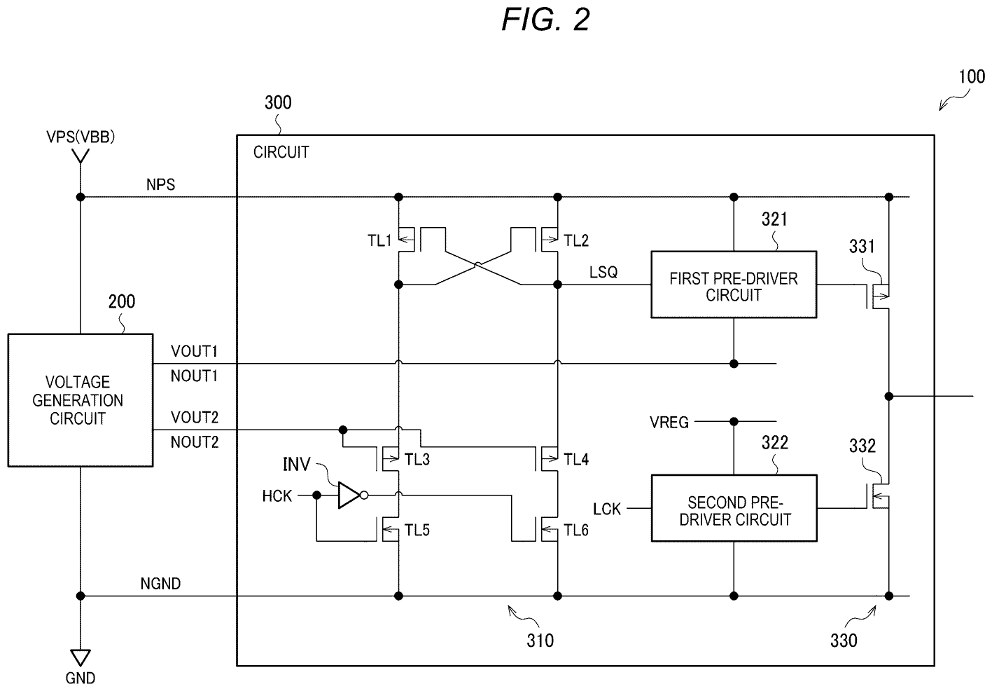

FIG. 2 shows a configuration example of a circuit device 100 including the voltage generation circuit 200 and a circuit 300 in the subsequent stage. Here, a bridge circuit and a drive circuit thereof will be described as an example of the circuit 300 using the first output voltage VOUT1 and the second output voltage VOUT2, but the circuit 300 is not limited thereto. The circuit 300 includes a level shifter 310, a first pre-driver circuit 321, a second pre-driver circuit 322, and a driver circuit 330.

The driver circuit 330 is a bridge circuit. That is, the driver circuit 330 includes a high-side first drive transistor 331 coupled between the power supply node NPS and the output node of the drive voltage, and a low-side second drive transistor 332 coupled between the output node of the drive voltage and the ground node NGND. The first drive transistor 331 is a P-type MOS transistor, and the second drive transistor 332 is an N-type MOS transistor. The first drive transistor 331 and the second drive transistor 332 are alternately turned on or off to drive a load such as a motor. Although an example in which the driver circuit 330 is a half-bridge circuit is described here, the driver circuit 330 may be an H-bridge circuit.

The level shifter 310 includes an inverter circuit INV, P-type MOS transistors TL1 to TL4, and N-type MOS transistors TL5 and TL6. The coupling relationship is as illustrated. The operation will be described below.

The level shifter 310 level-shifts a control signal HCK from a control circuit (not shown) and outputs the result as a signal LSQ. The control signal HCK is a signal for controlling the first drive transistor 331 of the driver circuit 330 to be turned on or off. It is assumed that the power supply voltage VPS is the given power supply voltage VBB. The high level of the control signal HCK is a logic power supply voltage lower than the given power supply voltage VBB, and the low level is the ground voltage GND. The high level of the signal LSQ is the given power supply voltage VBB, and the low level is a voltage that is higher than the second output voltage VOUT2 by approximately the threshold voltage of the P-type MOS transistor TL4. The second output voltage VOUT2 is, for example, a voltage lower than the first output voltage VOUT1 by approximately the threshold voltage of the P-type MOS transistor TL4. Then, the low level of the signal LSQ is substantially the same as the first output voltage VOUT1.

The first pre-driver circuit 321 includes one or more stages of inverter circuits or the like, and drives the gate of the first drive transistor 331 of the driver circuit 330 by buffering the signal LSQ. The high-potential-side power supply node of the first pre-driver circuit 321 is coupled to the power supply node NPS, and the low-potential-side power supply node is coupled to the first output node NOUT1 of the voltage generation circuit 200.

The second pre-driver circuit 322 includes one or more stages of inverter circuits and the like, and drives the gate of the second drive transistor 332 of the driver circuit 330 by buffering a control signal LCK from a control circuit (not illustrated). The control signal LCK is a signal for controlling the second drive transistor 332 to be turned on or off. A power supply voltage VREG is supplied to the high-potential-side power supply node of the second pre-driver circuit 322, and the low-potential-side power supply node is coupled to the ground node NGND. The power supply voltage VREG is supplied from, for example, a regulator that steps down the given power supply voltage VBB. The power supply voltage VREG is higher than the ground voltage GND and lower than the first output voltage VOUT1.

It is assumed that VOUT1<VPS is satisfied in the rising time of the power supply voltage VPS. Then, the output of the first pre-driver circuit 321 becomes unstable, and a malfunction that the first drive transistor 331 of the driver circuit 330 is turned on may occur. When the first drive transistor 331 is turned on, a current flows from the power supply node NPS to the load via the first drive transistor 331, and the first drive transistor 331 or the load may fail. According to the present embodiment, the first output voltage VOUT1 is fixed to the power supply voltage VPS by the first potential fixing circuit 231 of the voltage generation circuit 200 in the rising time of the power supply voltage VPS. As a result, the output of the first pre-driver circuit 321 is determined to be the power supply voltage VPS and the first drive transistor 331 of the driver circuit 330 is maintained in the off state, and thus a malfunction or failure can be prevented.

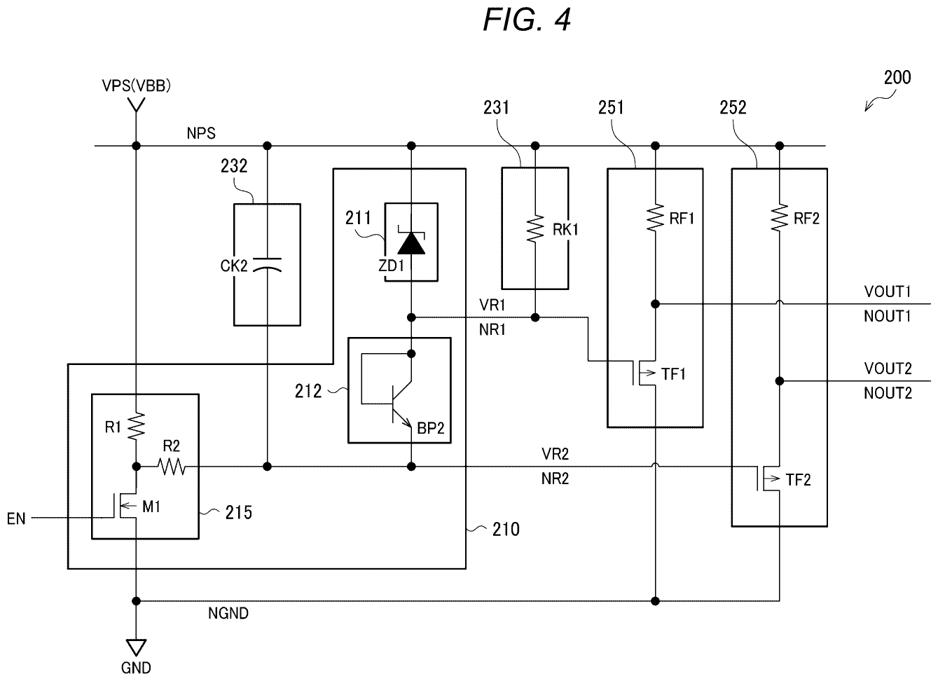

Further, it is assumed that VOUT2<VPS is satisfied in the rising time of the power supply voltage VPS. Then, the signal LSQ output from the level shifter 310 to the first pre-driver circuit 321 becomes unstable, and the same malfunction or failure as described above may occur. According to the present embodiment, the second output voltage VOUT2 is fixed to the power supply voltage VPS by the second potential fixing circuit 232 of the voltage generation circuit 200 in the rising time of the power supply voltage VPS. Accordingly, the signal LSQ output by the level shifter 310 is determined to be the power supply voltage VPS, and a malfunction or failure can be prevented. These problems and solutions will be described again in more specific configuration examples in FIGS. 4 to 7.

FIG. 3 shows a first detailed configuration example of the voltage generation circuit 200. The description of the same parts as those in the configuration example in FIG. 1 will be omitted as appropriate.

The bias voltage generation circuit 210 includes a first reference voltage setting circuit 211, a second reference voltage setting circuit 212, and a bias circuit 215.

The first reference voltage setting circuit 211 is coupled between the power supply node NPS and the first bias node NR1, and sets the potential difference between the given power supply voltage VBB and the first bias voltage VR1 to a first reference voltage when a bias current flows. The first reference voltage setting circuit 211 includes, for example, a reverse Zener diode or a plurality of reverse Zener diodes coupled in series. “Reverse” means that the anode is coupled to the node at the low-potential side and the cathode is coupled to the node at the high-potential side. In this case, the first reference voltage is set based on the Zener voltage of the Zener diode. Alternatively, the first reference voltage setting circuit 211 may include one or more reverse Zener diodes and one or more forward diodes coupled in series. “Forward” means that the anode is coupled to the node at the high-potential side and the cathode is coupled to the node at the low-potential side. In this case, the first reference voltage is set based on the Zener voltage of the Zener diode and the forward voltage of the diode.

The second reference voltage setting circuit 212 is coupled between the first bias node NR1 and the second bias node NR2, and sets the potential difference between the first bias voltage VR1 and the second bias voltage VR2 to a second reference voltage when the bias current flows. The second reference voltage setting circuit 212 includes, for example, a forward diode or a plurality of forward diodes coupled in series. Alternatively, the second reference voltage setting circuit 212 may include one or more forward diodes and one or more reverse Zener diodes coupled in series.

The bias circuit 215 supplies a bias current to the first reference voltage setting circuit 211 and the second reference voltage setting circuit 212. Specifically, the bias circuit 215 includes a current source IB that causes a bias current to flow from the second bias node NR2 to the ground node NGND. The current source IB supplies the bias current, and thus the bias current flows from the power supply node NPS to the second bias node NR2 through the first reference voltage setting circuit 211 and the second reference voltage setting circuit 212. As a result, the first bias voltage VR1 and the second bias voltage VR2 are generated. The bias circuit 215 supplies a bias current when an enable signal EN from a control circuit (not shown) is enabled.

The first follower circuit 251 is a source follower circuit, and includes a resistor RF1 and a P-type MOS transistor TF1. The resistor RF1 is coupled between the power supply node NPS and the first output node NOUT1. The P-type MOS transistor TF1 has a source coupled to the first output node NOUT1, a drain coupled to the ground node NGND, and a gate coupled to the first bias node NR1. The first output voltage VOUT1 is a voltage higher than the first bias voltage VR1 by approximately the threshold voltage of the P-type MOS transistor TF1. That is, the potential difference between the given power supply voltage VBB and the first output voltage VOUT1 is lower than the first reference voltage set by the first reference voltage setting circuit 211 by approximately the threshold voltage of the P-type MOS transistor TF1.

The second follower circuit 252 is a source follower circuit, and includes a resistor RF2 and a P-type MOS transistor TF2. The resistor RF2 is coupled between the power supply node NPS and the second output node NOUT2. The P-type MOS transistor TF2 has a source coupled to the second output node NOUT2, a drain coupled to the ground node NGND, and a gate coupled to the second bias node NR2. The second output voltage VOUT2 is a voltage higher than the second bias voltage VR2 by approximately the threshold voltage of the P-type MOS transistor TF2. When the threshold values of the P-type MOS transistors TF1 and TF2 are the same, the potential difference between the first output voltage VOUT1 and the second output voltage VOUT2 is the second reference voltage set by the second reference voltage setting circuit 212.

FIG. 4 shows a second detailed configuration example of the voltage generation circuit 200. The description of the same parts as those in the configuration example in FIG. 1 or 3 will be omitted as appropriate.

The first reference voltage setting circuit 211 includes a Zener diode ZD1. The anode of the Zener diode ZD1 is coupled to the first bias node NR1, and the cathode thereof is coupled to the power supply node NPS.

The second reference voltage setting circuit 212 includes a diode-coupled NPN bipolar transistor BP2. The collector and the base of the NPN bipolar transistor BP2 are coupled to the first bias node NR1, and the emitter is coupled to the second bias node NR2.

The bias circuit 215 includes a resistor R1, a resistor R2, and an N-type MOS transistor M1. One end of the resistor R1 is coupled to the power supply node NPS, and the other end is coupled to the drain of the N-type MOS transistor M1. One end of the resistor R2 is coupled to the second bias node NR2, and the other end is coupled to the drain of the N-type MOS transistor M1. The source of the N-type MOS transistor M1 is coupled to the ground node NGND. The enable signal EN is input to the gate of the N-type MOS transistor M1. When the enable signal EN is at the low level, the N-type MOS transistor M1 is off, the bias circuit 215 is disabled, and the bias current is not supplied. When the enable signal EN is at the high level, the N-type MOS transistor M1 is on, the bias circuit 215 is enabled, and the bias current is supplied.

The first potential fixing circuit 231 includes a resistor RK1 provided between the power supply node NPS and the first bias node NR1. One end of the resistor RK1 is coupled to the power supply node NPS, and the other end is coupled to the first bias node NR1. The resistance value of the resistor RK1 is set such that the Zener diode ZD1 is turned on when the bias circuit 215 causes the bias current to flow. That is, the resistance value of the resistor RK1 is set so that the voltage drop when the bias current flows through the resistor RK1 exceeds the Zener voltage.

The second potential fixing circuit 232 includes a capacitor CK2 provided between the power supply node NPS and the second bias node NR2. One end of the capacitor CK2 is coupled to the power supply node NPS, and the other end is coupled to the second bias node NR2.

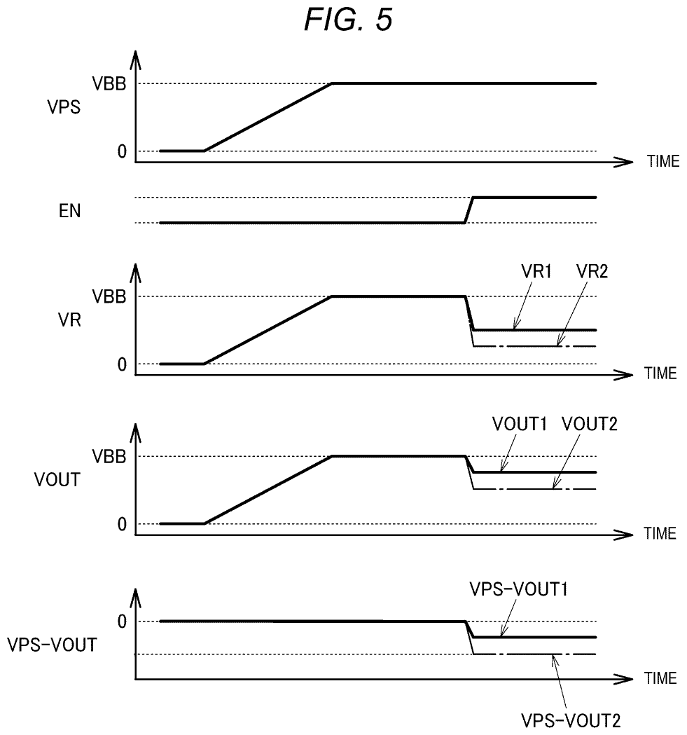

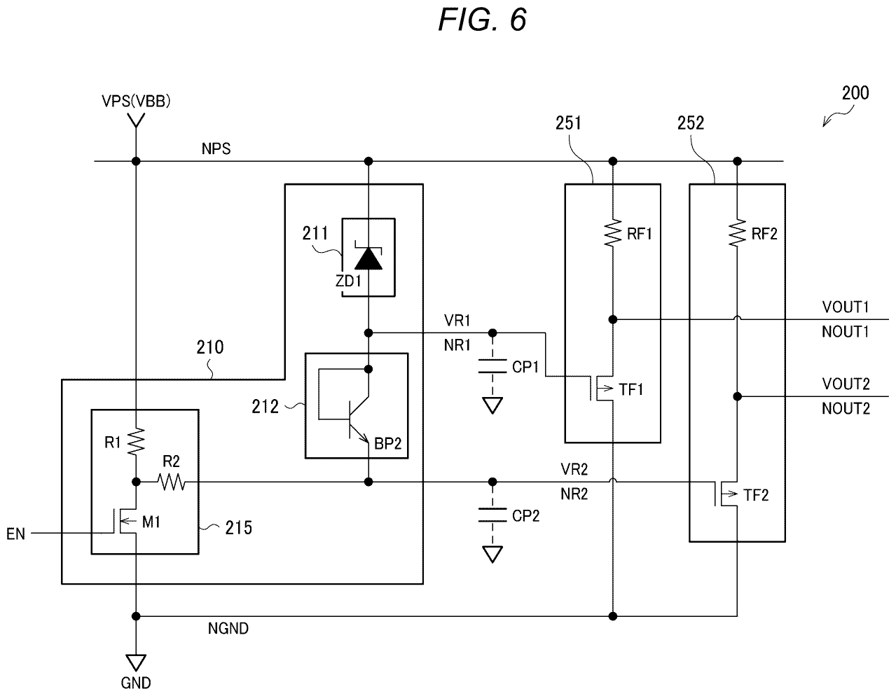

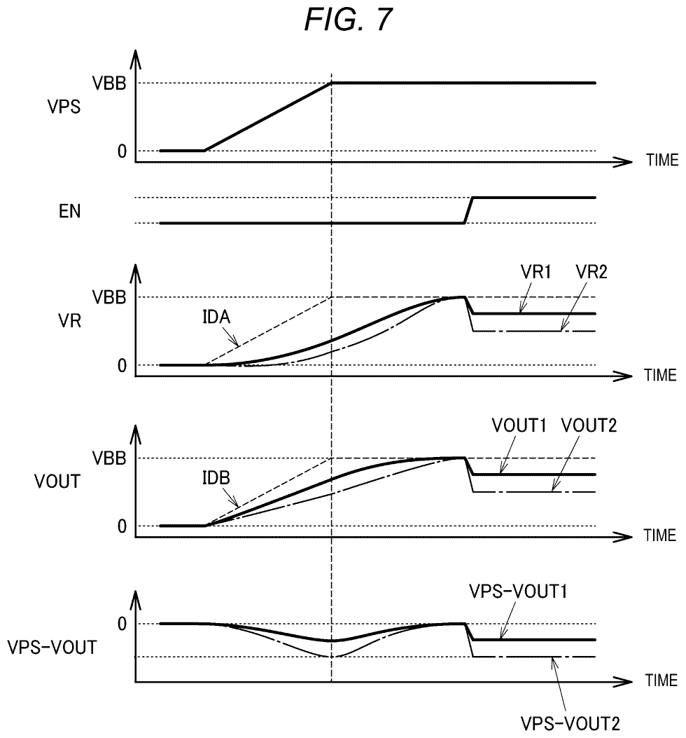

FIG. 5 shows a signal waveform example illustrating an operation of the second detailed configuration example of the voltage generation circuit 200. First, a configuration example and a signal waveform example of a comparative example will be described with reference to FIGS. 6 and 7, and the waveform example in FIG. 5 will be described in comparison therewith.

FIG. 6 shows the configuration example of the comparative example. In the comparative example, the first potential fixing circuit 231 and the second potential fixing circuit 232 are omitted from the configuration example in FIG. 4. A parasitic capacitance CP1 is provided between the first bias node NR1 and the ground node NGND, and a parasitic capacitance CP2 is provided between the second bias node NR2 and the ground node NGND. These parasitic capacitances are generated by wiring parasitic capacitances of the respective bias nodes, parasitic capacitances of circuit elements coupled to the respective bias nodes, or the like.

FIG. 7 shows the signal waveform example of the comparative example. The enable signal EN changes from the low level to the high level after the power supply is activated and the power supply voltage VPS becomes the given power supply voltage VBB. The bias circuit 215 is disabled while the enable signal EN is at the low level, and does not supply the bias current to the first reference voltage setting circuit 211 and the second reference voltage setting circuit 212. Hereinafter, it is assumed that the ground voltage GND is 0 V.

The power supply voltage VPS is 0 V before the power supply is activated. Therefore, the first bias voltage VR1, the second bias voltage VR2, the first output voltage VOUT1, and the second output voltage VOUT2 are 0 V. Concurrently, the potential differences between the ends of the parasitic capacitances CP1 and CP2 are 0 V.

When the power supply is activated, the power supply voltage VPS rises from 0 V to the given power supply voltage VBB. The waveform of the bias voltage VR indicated by the broken line and labeled IDA shows a waveform when the first bias voltage VR1 and the second bias voltage VR2 ideally follow the power supply voltage VPS. In practice, the first bias voltage VR1 is maintained around 0 V by the parasitic capacitance CP1 until the power supply voltage VPS exceeds the Zener voltage of the Zener diode ZD1. After the power supply voltage VPS rises and the Zener diode ZD1 is turned on, the parasitic capacitance CP1 is charged and the first bias voltage VR1 rises. Similarly, the second bias voltage VR2 is maintained around 0 V by the parasitic capacitance CP2 until the power supply voltage VPS exceeds a voltage obtained by adding the Zener voltage and the forward voltage of the diode of the NPN bipolar transistor BP2. Note that, it is assumed that the resistor R1 has a high resistance, and charging of the parasitic capacitance CP2 via the resistors R1 and R2 can be ignored. After the power supply voltage VPS rises and the Zener diode ZD1 and the diode are turned on, the parasitic capacitance CP2 is charged and the second bias voltage VR2 rises.

The waveform of the output voltage VOUT indicated by the broken line and labeled IDB shows a waveform when the first output voltage VOUT1 and the second output voltage VOUT2 ideally follow the power supply voltage VPS. In practice, as described above, in the rising time of the power supply voltage VPS, a potential difference is generated between the power supply voltage VPS and the first bias voltage VR1, and a potential difference is generated between the power supply voltage VPS and the second bias voltage VR2. When these potential differences are higher than the threshold voltages of the N-type transistors TF1 and TF2, the N-type transistors TF1 and TF2 are turned on. Therefore, in the rising time of the power supply voltage VPS, the first output voltage VOUT1 and the second output voltage VOUT2 are lower than the power supply voltage VPS. With reference to the power supply voltage VPS, VPS-VOUT1 and VPS-VOUT2 temporarily fall below 0 V in the rising time of the power supply voltage VPS. As described above, when the first output voltage VOUT1 and the second output voltage VOUT2 are lower than the power supply voltage VPS in the rising time of the power supply voltage VPS, as described with reference to FIG. 2 and the like, the circuit 300 in the subsequent stage using the first output voltage VOUT1 and the second output voltage VOUT2 may malfunction or fail.

The description returns to the signal waveform example in the present embodiment in FIG. 5. As described above with reference to FIG. 4, in the present embodiment, the resistor RK1 of the first potential fixing circuit 231 and the capacitor CK2 of the second potential fixing circuit 232 are provided.

In the rising time of the power supply voltage VPS, the enable signal EN is at the low level. The bias circuit 215 does not supply the bias current to the first reference voltage setting circuit 211 and the second reference voltage setting circuit 212 while the enable signal EN is at the low level. Concurrently, the power supply node NPS and the first bias node NR1 are coupled via the resistor RK1, and thus the first bias voltage VR1 follows the power supply voltage VPS at substantially the same voltage. The resistance value of the resistor RK1 is set so that the parasitic capacitance CP1 in FIG. 6 can be charged. Further, the power supply node NPS and the second bias node NR2 are coupled via the capacitor CK2, and thus the second bias voltage VR2 follows the power supply voltage VPS at substantially the same voltage. The capacitance value of the capacitor CK2 is sufficiently larger than the parasitic capacitance CP2 in FIG. 6.

Since there is almost no potential difference between the power supply voltage VPS and the first bias voltage VR1 in the rising time of the power supply voltage VPS, the P-type MOS transistor TF1 is not turned on. Therefore, the first output voltage VOUT1 follows the power supply voltage VPS at substantially the same voltage. Similarly, since there is almost no potential difference between the power supply voltage VPS and the second bias voltage VR2, the P-type MOS transistor TF2 is not turned on. Therefore, the second output voltage VOUT2 follows the power supply voltage VPS at substantially the same voltage. Since the first output voltage VOUT1 and the second output voltage VOUT2 do not become lower with respect to the power supply voltage VPS in the rising time of the power supply voltage VPS, the malfunction or failure of the subsequent circuit 300 as described above with reference to FIG. 2 and the like can be prevented.

When the enable signal EN changes from the low level to the high level, the bias circuit 215 supplies the bias current. Accordingly, the potential difference between the given power supply voltage VBB and the first bias voltage VR1 is set based on the Zener voltage of the Zener diode ZD1. Further, the potential difference between the first bias voltage VR1 and the second bias voltage VR2 is set by the forward voltage of the diode by the NPN bipolar transistor BP2. Then, the first follower circuit 251 outputs the first output voltage VOUT1 following the first bias voltage VR1, and the second follower circuit 252 outputs the second output voltage VOUT2 following the second bias voltage VR2.

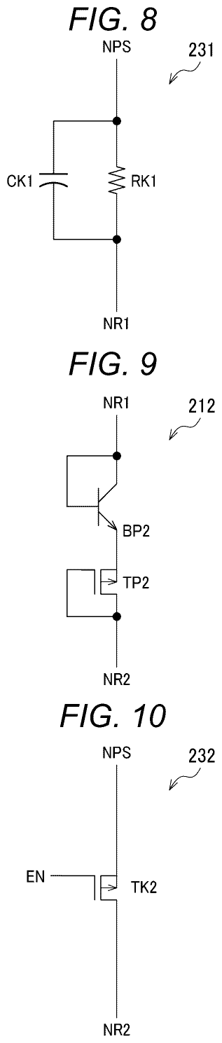

FIG. 8 shows a first other configuration example of the first potential fixing circuit 231. The first potential fixing circuit 231 includes the resistor RK1 and the capacitor CK1 coupled in parallel between the power supply node NPS and the first bias node NR1. Specifically, one end of the resistor RK1 and one end of the capacitor CK1 are coupled to the power supply node NPS, and the other ends are coupled to the first bias node NR1.

FIG. 9 shows another configuration example of the second reference voltage setting circuit 212. The second reference voltage setting circuit 212 includes the NPN bipolar transistor BP2 and a P-type MOS transistor TP2 coupled in series between the first bias node NR1 and the second bias node NR2. Each transistor is diode-coupled. Specifically, the collector and the base of the NPN bipolar transistor BP2 are coupled to the first bias node NR1, and the emitter is coupled to the second bias node NR2. The source of the P-type MOS transistor TP2 is coupled to the emitter of the NPN bipolar transistor BP2, and the drain and the gate are coupled to the second bias node NR2.

In the present configuration example, the second reference voltage as the potential difference between the first bias voltage VR1 and the second bias voltage VR2 is a voltage obtained by adding the forward voltage of the diode by the NPN bipolar transistor BP2 and the forward voltage of the diode by the P-type MOS transistor TP2.

FIG. 10 shows another configuration example of the second potential fixing circuit 232. The second potential fixing circuit 232 includes a P-type MOS transistor TK2 provided between the power supply node NPS and the second bias node NR2. Specifically, the source of the P-type MOS transistor TK2 is coupled to the power supply node NPS, and the drain thereof is coupled to the second bias node NR2. The enable signal EN is input to the gate of the P-type MOS transistor TK2. The P-type MOS transistor TK2 is on when the enable signal EN is at the low level and fixes the second bias voltage VR2 to the power supply voltage VPS, and is off when the enable signal EN is at the high level.

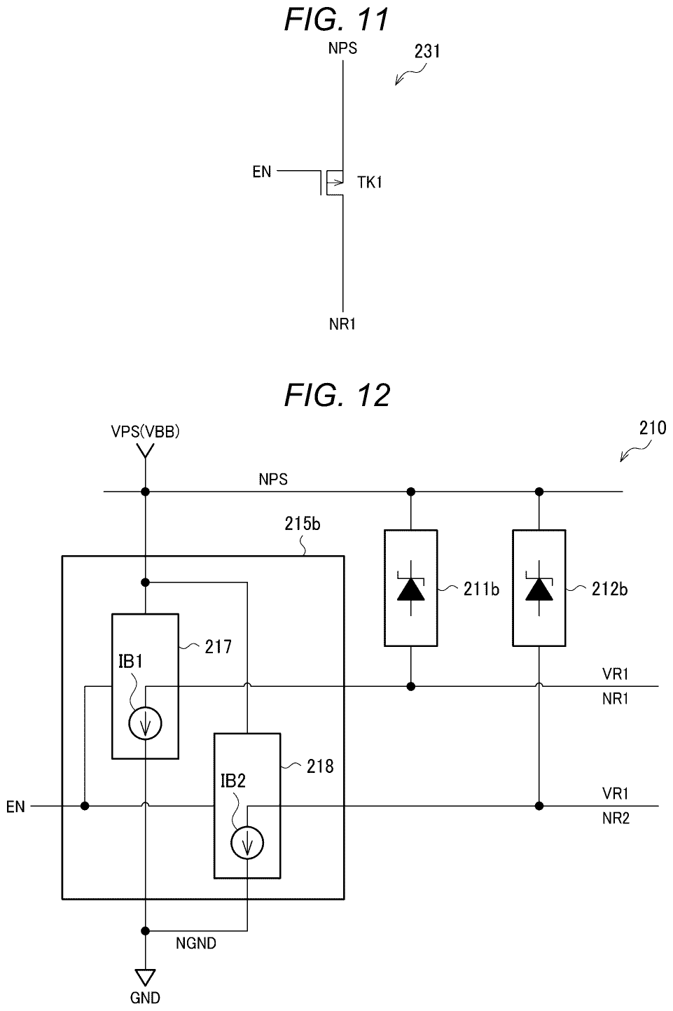

FIG. 11 shows a second other configuration example of the first potential fixing circuit 231. The first potential fixing circuit 231 includes a P-type MOS transistor TK1 provided between the power supply node NPS and the first bias node NR1. Specifically, the source of the P-type MOS transistor TK1 is coupled to the power supply node NPS, and the drain thereof is coupled to the first bias node NR1. The enable signal EN is input to the gate of the P-type MOS transistor TK1. The P-type MOS transistor TK1 is on when the enable signal EN is at the low level and fixes the first bias voltage VR1 to the power supply voltage VPS, and is off when the enable signal EN is at the high level.

FIG. 12 shows a first other configuration example of the bias voltage generation circuit 210. The bias voltage generation circuit 210 includes a first reference voltage setting circuit 211b, a second reference voltage setting circuit 212b, and a bias circuit 215b. The bias circuit 215b supplies a first bias current to the first reference voltage setting circuit 211b and supplies a second bias current to the second reference voltage setting circuit 212b. The bias circuit 215b includes a first bias circuit 217 and a second bias circuit 218.

The first bias circuit 217 supplies the first bias current to the first reference voltage setting circuit 211b. Specifically, the first bias circuit 217 includes a current source IB1 that causes the first bias current to flow from the first bias node NR1 to the ground node NGND. The current source IB1 causes the first bias current to flow, and thus the bias current flows from the power supply node NPS to the first bias node NR1 through the first reference voltage setting circuit 211b.

The second bias circuit 218 supplies a second bias current to the second reference voltage setting circuit 212b. Specifically, the second bias circuit 218 includes a second current source IB2 that causes the second bias current to flow from the second bias node NR2 to the ground node NGND. The second current source IB2 causes the second bias current to flow, and thus the bias current flows from the power supply node NPS to the second bias node NR2 through the second reference voltage setting circuit 212b.

Each of the first bias circuit 217 and the second bias circuit 218 is configured similarly to the bias circuit 215 described with reference to FIG. 1, FIG. 3, FIG. 4, or the like.

The first reference voltage setting circuit 211b is coupled between the power supply node NPS and the first bias node NR1, and sets the potential difference between the given power supply voltage VBB and the first bias voltage VR1 to the first reference voltage when the first bias current flows.

The second reference voltage setting circuit 212b is coupled between the power supply node NPS and the second bias node NR2, and sets the potential difference between the given power supply voltage VBB and the second bias voltage VR2 to the second reference voltage when the second bias current flows. The second reference voltage in the present configuration example is larger than the first reference voltage.

The first reference voltage setting circuit 211b is configured similarly to the first reference voltage setting circuit 211 described with reference to FIG. 3, FIG. 4, or the like. The second reference voltage setting circuit 212b includes, for example, the first reference voltage setting circuit 211 and the second reference voltage setting circuit 212 described with reference to FIG. 3, FIG. 4, or the like.

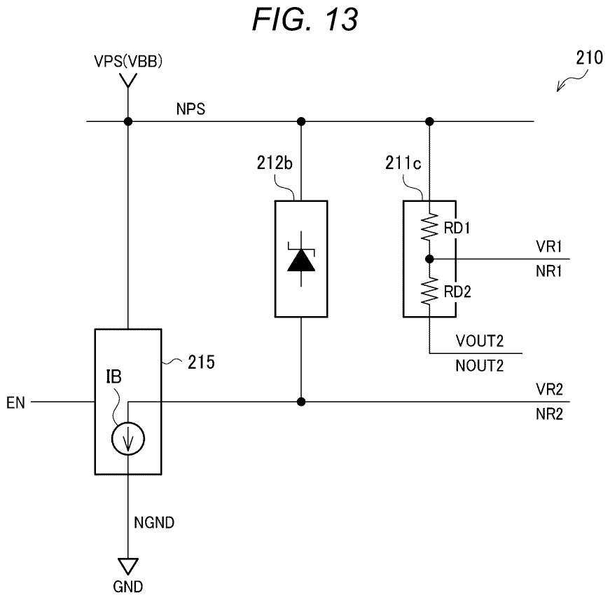

FIG. 13 shows a second other configuration example of the bias voltage generation circuit 210. The bias voltage generation circuit 210 includes a first reference voltage setting circuit 211c, the second reference voltage setting circuit 212b, and the bias circuit 215.

The first reference voltage setting circuit 211c is a voltage dividing circuit. The voltage dividing circuit divides the voltage between the power supply voltage VPS and the second output voltage VOUT2, and outputs the result to the first bias node NR1 as the first bias voltage VR1. The first reference voltage setting circuit 211c includes a resistor RD1 and a resistor RD2 coupled in series between the power supply node NPS and the second output node NOUT2. The node between the resistor RD1 and the resistor RD2 is coupled to the first bias node NR1.

In the present configuration example, the first bias voltage VR1 is higher than the second output voltage VOUT2. Therefore, the first output voltage VOUT1 following the first bias voltage VR1 is higher than the second output voltage VOUT2.

In the present embodiment, the circuit device 100 generates the first output voltage VOUT1 and the second output voltage VOUT2 lower than the first output voltage VOUT1 from the power supply voltage VPS supplied to the power supply node NPS. The circuit device 100 includes the bias voltage generation circuit 210, the first follower circuit 251, the second follower circuit 252, and the first potential fixing circuit 231. The bias voltage generation circuit 210 generates the first bias voltage VR1 and the second bias voltage VR2 with reference to the power supply voltage VPS, outputs the first bias voltage VR1 to the first bias node NR1, and outputs the second bias voltage VR2 to the second bias node NR2. The first follower circuit 251 outputs the first output voltage VOUT1 following the first bias voltage VR1 to the first output node NOUT1. The second follower circuit 252 outputs the second output voltage VOUT2 following the second bias voltage VR2 to the second output node NOUT2. The first potential fixing circuit 231 fixes the potential of the first bias node NR1 to the potential of the power supply node NPS in the rising time of the power supply voltage VPS.

In the present embodiment, the first bias voltage VR1 is generated with reference to the power supply voltage VPS, and the first output voltage VOUT1 following the first bias voltage VR1 is generated. That is, the first output voltage VOUT1 is generated with reference to the power supply voltage VPS. In such a case, as described with reference to FIGS. 6 and 7 and the like, the first output voltage VOUT1 may be lower than the power supply voltage VPS in the rising time of the power supply voltage VPS. Then, the circuit 300 in the subsequent stage using the first output voltage VOUT1 may malfunction or fail in the rising time of the power supply voltage VPS. According to the present embodiment, the first potential fixing circuit 231 fixes the potential of the first bias node NR1 to the potential of the power supply node NPS in the rising time of the power supply voltage VPS. The first output voltage VOUT1 follows the first bias voltage VR1 fixed to the power supply voltage VPS, and follows the power supply voltage VPS. Accordingly, the difference between the first output voltage VOUT1 and the power supply voltage VPS is no longer generated in the rising time of the power supply voltage VPS, and the circuit 300 in the subsequent stage using the first output voltage VOUT1 no longer malfunctions or fails.

In the present embodiment, the circuit device 100 may include the second potential fixing circuit 232. The second potential fixing circuit 232 may fix the potential of the second bias node NR2 to the potential of the power supply node NPS in the rising time of the power supply voltage VPS.

According to the present embodiment, the second output voltage VOUT2 follows the second bias voltage VR2 fixed to the power supply voltage VPS, and follows the power supply voltage VPS. Accordingly, the difference between the second output voltage VOUT2 and the power supply voltage VPS is no longer generated in the rising time of the power supply voltage VPS, and the circuit 300 in the subsequent stage using the second output voltage VOUT2 no longer malfunctions or fails.

In the embodiment in FIG. 3 and the like, the bias voltage generation circuit 210 may include the first reference voltage setting circuit 211 and the second reference voltage setting circuit 212. The first reference voltage setting circuit 211 may be provided between the power supply node NPS and the first bias node NR1 and set the potential difference between the power supply node NPS and the first bias node NR1 to the first reference voltage. The second reference voltage setting circuit 212 may be provided between the first bias node NR1 and the second bias node NR2 and set the potential difference between the first bias node NR1 and the second bias node NR2 to the second reference voltage.

According to the present embodiment, the first reference voltage setting circuit 211 sets the potential difference between the power supply node NPS and the first bias node NR1 to the first reference voltage, thereby generating the first bias voltage VR1 with reference to the power supply voltage VPS. Thus, the first output voltage VOUT1 following the first bias voltage VR1 is generated with reference to the power supply voltage VPS. According to the present embodiment, the second reference voltage setting circuit 212 sets the potential difference between the first bias node NR1 and the second bias node NR2 to the second reference voltage, thereby generating the second bias voltage VR2 with reference to the first bias voltage VR1 that is reference to the power supply voltage VPS. Accordingly, the second output voltage VOUT2 following the second bias voltage VR2 is generated with reference to the power supply voltage VPS.

In the embodiment in FIG. 4 and the like, the first reference voltage setting circuit 211 may generate the first reference voltage based on the Zener voltage of the Zener diode ZD1. The second reference voltage setting circuit 212 may generate the second reference voltage by the forward voltage of the diode. In FIG. 4, the base-emitter voltage of the diode-coupled NPN bipolar transistor BP2 corresponds to the forward voltage of the diode.

According to the present embodiment, the first bias voltage VR1 lower than the power supply voltage VPS based on the Zener voltage can be generated with reference to the power supply voltage VPS. Further, the second bias voltage VR2 lower than the power supply voltage VPS by a voltage obtained by adding the Zener voltage and the forward voltage of the diode can be generated with reference to the power supply voltage VPS.

In the embodiment in FIG. 3 and the like, the bias voltage generation circuit 210 may include the bias circuit 215 that supplies the bias current to the first reference voltage setting circuit 211 and the second reference voltage setting circuit 212.

According to the present embodiment, the bias circuit 215 supplies the bias current to the first reference voltage setting circuit 211 and the second reference voltage setting circuit 212, and thus the first reference voltage setting circuit 211 can set the first reference voltage, and the second reference voltage setting circuit 212 can set the second reference voltage. For example, the bias current is supplied to the Zener diode ZD1, and thus the Zener diode ZD1 generates the Zener voltage as the first reference voltage. Further, the bias current is supplied to the diode, and thus the diode generates the forward voltage as the second reference voltage.

In the embodiment in FIG. 3 and the like, the bias circuit 215 may not supply the bias current to the first reference voltage setting circuit 211 and the second reference voltage setting circuit 212 in the rising time of the power supply voltage VPS.

According to the present embodiment, the first reference voltage and the second reference voltage are not set in the rising time of the power supply voltage VPS. Accordingly, the first potential fixing circuit 231 can fix the first bias voltage VR1 to the power supply voltage VPS, and the second potential fixing circuit 232 can fix the second bias voltage VR2 to the power supply voltage VPS.

In the embodiment in FIG. 12, the bias voltage generation circuit 210 may include the first reference voltage setting circuit 211b and the second reference voltage setting circuit 212b. The first reference voltage setting circuit 211b may be provided between the power supply node NPS and the first bias node NR1 and set the potential difference between the power supply node NPS and the first bias node NR1 to the first reference voltage. The second reference voltage setting circuit 212b may be provided between the power supply node NPS and the second bias node NR2 and set the potential difference between the power supply node NPS and the second bias node NR2 to the second reference voltage.

In the embodiment in FIG. 12, the bias voltage generation circuit 210 may include the bias circuit 215b that supplies the bias current to the first reference voltage setting circuit 211 and the second reference voltage setting circuit 212.

According to the present embodiment, the first bias voltage VR1 is generated with reference to the power supply voltage VPS, and thus the first output voltage VOUT1 following the first bias voltage VR1 is generated with reference to the power supply voltage VPS. Similarly, the second bias voltage VR2 is generated with reference to the power supply voltage VPS, and thus the second output voltage VOUT2 following the second bias voltage VR2 is generated with reference to the power supply voltage VPS.

In the embodiment in FIG. 12, the bias circuit 215b may not supply the bias current to the first reference voltage setting circuit 211b and the second reference voltage setting circuit 212b in the rising time of the power supply voltage VPS.

According to the present embodiment, the first reference voltage and the second reference voltage are not set in the rising time of the power supply voltage VPS. Accordingly, the first potential fixing circuit 231 can fix the first bias voltage VR1 to the power supply voltage VPS, and the second potential fixing circuit 232 can fix the second bias voltage VR2 to the power supply voltage VPS.

In the embodiment in FIG. 4, 8, 11, or the like, the first potential fixing circuit 231 may include at least one of a resistor, a capacitor, and a transistor. When a transistor is used, the transistor is turned on in the rising time of the power supply voltage VPS.

According to the present embodiment, the power supply node NPS and the first bias node NR1 are coupled by at least one of a resistor, a capacitor, and a transistor, and thus the first bias voltage VR1 is fixed to the power supply voltage VPS in the rising time of the power supply voltage VPS.

In the embodiment in FIG. 4, FIG. 10, or the like, the second potential fixing circuit 232 may include at least one of a capacitor and a transistor.

According to the present embodiment, the power supply node NPS and the second bias node NR2 are coupled by at least one of a capacitor and a transistor, and thus the second bias voltage VR2 is fixed to the power supply voltage VPS in the rising time of the power supply voltage VPS.

In the embodiment shown in FIG. 2 and the like, the circuit device 100 may include a circuit that operates with the power supply voltage VPS as a high-potential-side power supply voltage and the first output voltage VOUT1 as a low-potential-side power supply voltage. In the example in FIG. 2, the first pre-driver circuit 321 is the circuit that operates with the power supply voltage VPS as the high-potential-side power supply voltage and the first output voltage VOUT1 as the low-potential-side power supply voltage.

When the first output voltage VOUT1 becomes lower than the power supply voltage VPS in the rising time of the power supply voltage VPS, the circuit that operates using the first output voltage VOUT1 as the low-potential-side power supply voltage may malfunction. In addition, due to the malfunction, a circuit element in the circuit device 100, an external circuit, or an external component may fail. According to the present embodiment, since the first output voltage VOUT1 is fixed to the power supply voltage VPS in the rising time of the power supply voltage VPS, no malfunction or failure occurs.

In the embodiment in FIG. 2, the circuit device 100 may include the first pre-driver circuit 321 that drives the first drive transistor 331 of the driver circuit 330, and the level shifter 310 that level-shifts and outputs the control signal HCK of the first pre-driver circuit 321 to the first pre-driver circuit 321. The first drive transistor 331 may be provided between the power supply node NPS and the output node of the drive voltage. The first pre-driver circuit 321 may operate with the power supply voltage VPS as the high-potential-side power supply voltage and the first output voltage VOUT1 as the low-potential-side power supply voltage. The level shifter 310 may output the power supply voltage VPS as the high level and the voltage with reference to the second output voltage VOUT2 as the low level.

When the first output voltage VOUT1 becomes lower than the power supply voltage VPS in the rising time of the power supply voltage VPS, the first pre-driver circuit 321 operates and the first drive transistor 331 is turned on, which causes a malfunction or failure. Alternatively, when the second output voltage VOUT2 becomes lower than the power supply voltage VPS in the rising time of the power supply voltage VPS, the low level of the output of the level shifter 310 becomes lower than the power supply voltage VPS, and the low level is input to the first pre-driver circuit 321, which causes a malfunction or failure. According to the present embodiment, since the first output voltage VOUT1 is fixed to the power supply voltage VPS in the rising time of the power supply voltage VPS, the output of the first pre-driver circuit 321 that sets the first output voltage VOUT1 to the low-potential-side power supply voltage is fixed to the power supply voltage VPS. Further, since the second output voltage VOUT2 is fixed to the power supply voltage VPS in the rising time of the power supply voltage VPS, the output of the level shifter 310 that outputs the voltage with reference to the second output voltage VOUT2 as the low level is fixed to the power supply voltage VPS. As a result, a malfunction or failure does not occur in the rising time of the power supply voltage VPS.

### 2. Second Configuration Example

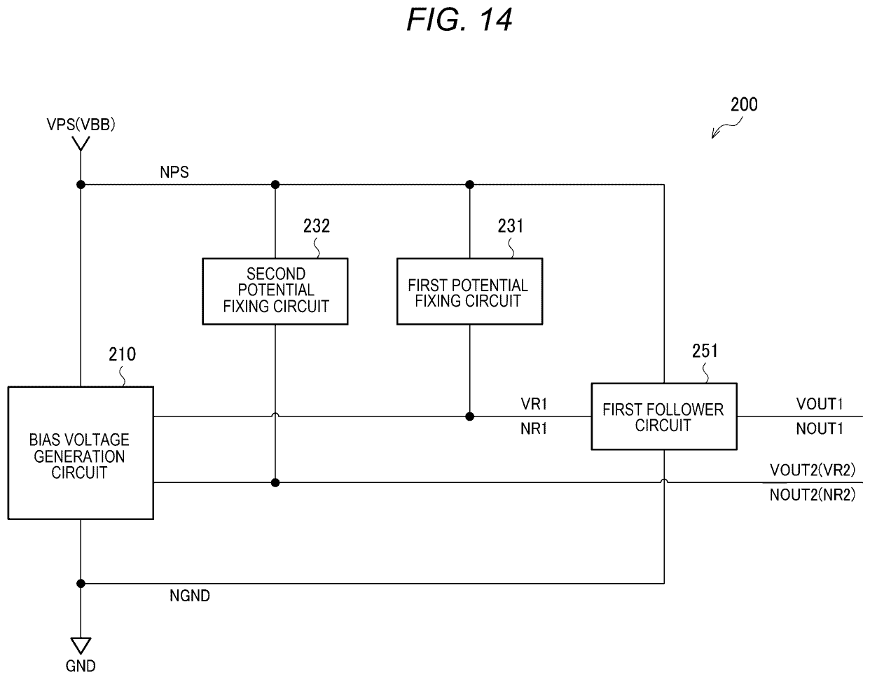

FIG. 14 shows a second configuration example of the voltage generation circuit 200 provided in the circuit device 100 of the present embodiment. Hereinafter, the description of the same parts as those of the first configuration example described with reference to FIGS. 1 to 13 will be omitted as appropriate, and the different parts from the first configuration example will be mainly described.

The voltage generation circuit 200 includes the bias voltage generation circuit 210, the first potential fixing circuit 231, the second potential fixing circuit 232, and the first follower circuit 251. In the second configuration example, the second follower circuit 252 is omitted from the first configuration example, and the second bias node NR2 is the second output node NOUT2. That is, the bias voltage generation circuit 210 outputs the second bias voltage VR2 to the second output node NOUT2 as the second output voltage VOUT2.

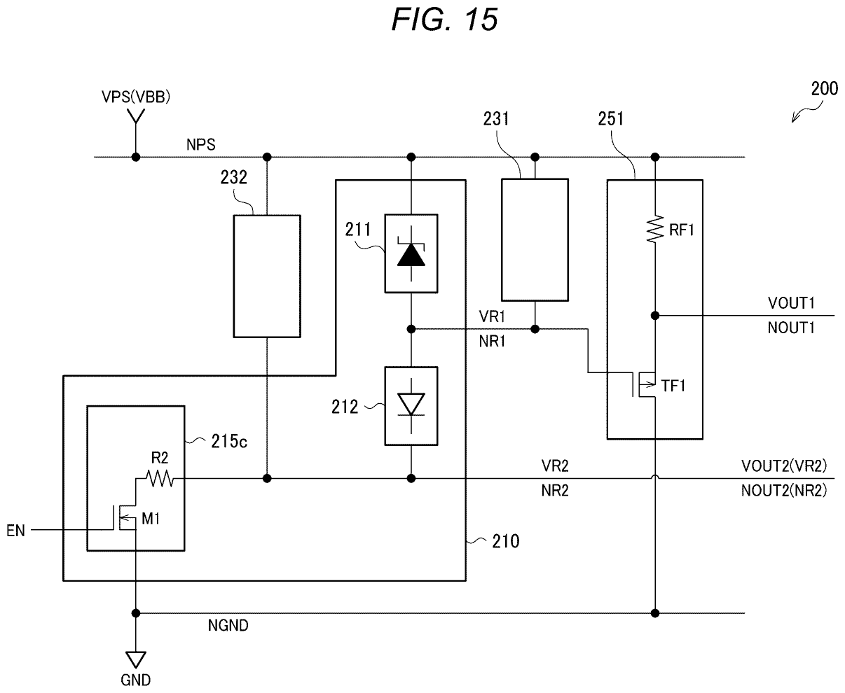

FIG. 15 shows a more detailed configuration example of the second configuration example of the voltage generation circuit 200. The bias voltage generation circuit 210 includes the first reference voltage setting circuit 211, the second reference voltage setting circuit 212, and a bias circuit 215c.

The bias circuit 215c includes the resistor R2 and the N-type MOS transistor M1. One end of the resistor R2 is coupled to the second bias node NR2, and the other end is coupled to the drain of the N-type MOS transistor M1. The source of the N-type MOS transistor M1 is coupled to the ground node NGND. The enable signal EN is input to the gate of the N-type MOS transistor M1.

In the present embodiment, the circuit device 100 generates the first output voltage VOUT1 and the second output voltage VOUT2 lower than the first output voltage VOUT1 from the power supply voltage VPS supplied to the power supply node NPS. The circuit device 100 includes the bias voltage generation circuit 210, the first follower circuit 251, and the first potential fixing circuit 231. The bias voltage generation circuit 210 generates the first bias voltage VR1 and the second bias voltage VR2 with reference to the power supply voltage VPS, outputs the first bias voltage VR1 to the first bias node NR1, and outputs the second bias voltage VR2 as the second output voltage VOUT2 to the second output node NOUT2 which is the second bias node NR2. The first follower circuit 251 outputs the first output voltage VOUT1 following the first bias voltage VR1 to a first output node NOUT1. The first potential fixing circuit 231 fixes the potential of the first bias node NR1 to the potential of the power supply node NPS in the rising time of the power supply voltage VPS.

According to the present embodiment, the first potential fixing circuit 231 fixes the potential of the first bias node NR1 to the potential of the power supply node NPS in the rising time of the power supply voltage VPS. The first output voltage VOUT1 follows the first bias voltage VR1 fixed to the power supply voltage VPS, and follows the power supply voltage VPS. Accordingly, the difference between the first output voltage VOUT1 and the power supply voltage VPS is no longer generated in the rising time of the power supply voltage VPS, and the circuit 300 in the subsequent stage using the first output voltage VOUT1 no longer malfunctions or fails.

In the present embodiment, the second bias voltage VR2 is output to the second output node NOUT2 not via a follower circuit. Concurrently, the second potential fixing circuit 232 may fix the potential of the second output node NOUT2 to the potential of the power supply node NPS in the rising time of the power supply voltage VPS. Accordingly, the difference between the second output voltage VOUT2 and the power supply voltage VPS is no longer generated in the rising time of the power supply voltage VPS, and the circuit 300 in the subsequent stage using the second output voltage VOUT2 no longer malfunctions or fails.

Although the present embodiment has been described in detail above, it will be easily understood by those skilled in the art that many modifications can be made without substantially departing from the novel matters and effects according to the present disclosure. Accordingly, all the modifications are within the scope of the present disclosure. For example, a term described at least once together with a different term having a broader meaning or the same meaning in the specification or the drawings can be replaced with the different term in any place in the specification or the drawings. All combinations of the present embodiment and the modifications are also within the scope of the present disclosure. The configurations, operations, and the like of the circuit device, the voltage generation circuit, the downstream circuit, the bias voltage generation circuit, the first follower circuit, the second follower circuit, the first potential fixing circuit, the second potential fixing circuit, and the like are not limited to those described in the present embodiment, and various modifications can be made.

What is claimed is:

1. A circuit device that generates a first output voltage and a second output voltage lower than the first output voltage from a power supply voltage supplied to a power supply node, the circuit device comprising:
a bias voltage generation circuit that generates a first bias voltage and a second bias voltage with reference to the power supply voltage, outputs the first bias voltage to a first bias node, and outputs the second bias voltage to a second bias node;
a first follower circuit that outputs the first output voltage following the first bias voltage to a first output node;
a second follower circuit that outputs the second output voltage following the second bias voltage to a second output node; and
a first potential fixing circuit that fixes a potential of the first bias node to a potential of the power supply node in a rising time of the power supply voltage.

2. A circuit device that generates a first output voltage and a second output voltage lower than the first output voltage from a power supply voltage supplied to a power supply node, the circuit device comprising:
a bias voltage generation circuit that generates a first bias voltage and a second bias voltage with reference to the power supply voltage, outputs the first bias voltage to a first bias node, and outputs the second bias voltage as the second output voltage to a second output node, which serves as a second bias node;
a first follower circuit that outputs the first output voltage following the first bias voltage to a first output node; and
a first potential fixing circuit that fixes a potential of the first bias node to a potential of the power supply node in a rising time of the power supply voltage.

3. The circuit device according to claim 1, further comprising a second potential fixing circuit that fixes a potential of the second bias node to a potential of the power supply node in the rising time of the power supply voltage.

4. The circuit device according to claim 1, wherein
the bias voltage generation circuit includes:
a first reference voltage setting circuit that is provided between the power supply node and the first bias node and sets a potential difference between the power supply node and the first bias node to a first reference voltage; and
a second reference voltage setting circuit that is provided between the first bias node and the second bias node and sets a potential difference between the first bias node and the second bias node to a second reference voltage.

5. The circuit device according to claim 4, wherein
the first reference voltage setting circuit generates the first reference voltage based on a Zener voltage of a Zener diode, and
the second reference voltage setting circuit generates the second reference voltage by a forward voltage of a diode.

6. The circuit device according to claim 4, wherein
the bias voltage generation circuit includes a bias circuit that supplies a bias current to the first reference voltage setting circuit and the second reference voltage setting circuit.

7. The circuit device according to claim 6, wherein
the bias circuit does not supply the bias current to the first reference voltage setting circuit and the second reference voltage setting circuit in the rising time of the power supply voltage.

8. The circuit device according to claim 1, wherein
the bias voltage generation circuit includes:
a first reference voltage setting circuit that is provided between the power supply node and the first bias node and sets a potential difference between the power supply node and the first bias node to a first reference voltage; and
a second reference voltage setting circuit that is provided between the power supply node and the second bias node and sets a potential difference between the power supply node and the second bias node to a second reference voltage.

9. The circuit device according to claim 8, wherein
the bias voltage generation circuit includes a bias circuit that supplies a bias current to the first reference voltage setting circuit and the second reference voltage setting circuit.

10. The circuit device according to claim 9, wherein
the bias circuit does not supply the bias current to the first reference voltage setting circuit and the second reference voltage setting circuit in the rising time of the power supply voltage.

11. The circuit device according to claim 1, wherein
the first potential fixing circuit includes at least one of a resistor, a capacitor, and a transistor.

12. The circuit device according to claim 3, wherein
the second potential fixing circuit includes at least one of a capacitor and a transistor.

13. The circuit device according to claim 1, further comprising a circuit that operates with the power supply voltage as a high-potential-side power supply voltage and the first output voltage as a low-potential-side power supply voltage.

14. The circuit device according to claim 1, further comprising:
a first pre-driver circuit that drives a first drive transistor of a driver circuit having the first drive transistor provided between the power supply node and an output node of a drive voltage; and
a level shifter that level-shifts a control signal of the first pre-driver circuit, wherein
the first pre-driver circuit operates with the power supply voltage as a high-potential-side power supply voltage and the first output voltage as a low-potential-side power supply voltage, and
the level shifter outputs the power supply voltage at a high level and a voltage with reference to the second output voltage at a low level.
